(19) United States
(12) Patent Application Publication
(10) Pub. No.: US 2021/0306700 A1
(43) Pub. Date: Sep. 30, 2021

(54) METHOD FOR DISPLAYING INTERACTION INFORMATION, AND TERMINAL

(71) Applicant: BEIJING DAJIA INTERNET INFORMATION TECHNOLOGY CO., LTD., Beijing (CN)

(72) Inventors: Wannan XIE, Beijing (CN); Qi ZHANG, Beijing (CN)

(21) Appl. No.: 17/202,059

(22) Filed: Mar. 15, 2021

(30) Foreign Application Priority Data
Mar. 31, 2020 (CN) 202010247422.4

(51) Int. Cl. H04N 21/431; H04N 21/2187; H04N 21/81; H04N 21/8545

(52) U.S. Cl. CPC H04N 21/4316; H04N 21/2187; H04N 21/8146; H04N 21/8545; H04N 21/8126

(57) ABSTRACT

A method for displaying interaction information includes: displaying a joint live streaming picture in a live streaming interface, wherein the joint live streaming picture includes a plurality of live streaming sub-pictures; playing, in each of the live streaming sub-pictures, live streaming video streams of a terminal corresponding to the live streaming sub-picture in a plurality of interaction rounds; and displaying interaction result information in the joint live streaming picture in response to an end of a last interaction round.

This application is based on and claims priority under 35 U.S.C. 119 to Chinese Patent application No. 202010247422.4, filed on Mar. 31, 2020 with the China National Intellectual Property Administration, and entitled “METHOD AND APPARATUS FOR DISPLAYING INTERACTION INFORMATION, AND TERMINAL AND STORAGE MEDIUM THEREOF,” the disclosure of which is incorporated herein by reference in its entirety.

### TECHNICAL FIELD

The present disclosure relates to the field of network technologies, and in particular, relates to a method for displaying interaction information, and a terminal.

### BACKGROUND

With the rapid development of network technologies, live streaming, as a form of entertainment, has gradually entered people's daily life. In the live streaming, anchors can set up live streaming rooms on mainstream live streaming platforms, and can further live-stream contents jointly with other anchors (commonly known as “microphone-connected live streaming”). In the case that two anchors live-streams their contents jointly, audiences can watch a joint live streaming picture on a live streaming page of either anchor; and the two anchors can compete for popularity through games, and the audiences can participate in the interactions by sending bullet screens or swiping gifts.

### SUMMARY

The present disclosure provides a method for displaying interaction information and a terminal.

In one aspect, a method for displaying interaction information is provided. The method includes: displaying a joint live streaming picture in a live streaming interface, wherein the joint live streaming picture includes a plurality of live streaming sub-pictures; playing, in each of the live streaming sub-pictures, live streaming video streams of a terminal corresponding to the live streaming sub-picture in a plurality of interaction rounds, wherein each of the interaction rounds includes a round of interactions of the terminal; and displaying interaction result information in the joint live streaming picture in response to an end of a last interaction round, wherein the interaction result information indicates an accumulated interaction result of the terminals in the plurality of interaction rounds.

In another aspect, a method for displaying interaction information is provided. The method is applicable to a target terminal, and includes: displaying a joint live streaming picture in a live streaming interface, wherein the joint live streaming picture includes a plurality of live streaming sub-pictures and a competition format switch option; displaying a plurality of switchable interactive competition formats in the joint live streaming picture in response to a trigger operation of the competition format switch option, wherein the interactive competition format indicates the number of interaction rounds under a competition format and the number of winnings required for victory; sending an interaction request to a terminal in response to a trigger operation of any one of the interactive competition formats, wherein the terminal corresponds to a target live streaming sub-picture, the target live streaming sub-picture including a live streaming sub-picture except a live streaming sub-picture corresponding to the target terminal, and the interaction request is initiated to request joint live streaming in the interactive competition format; and displaying live streaming video streams in the joint live streaming picture in response to acknowledgement information returned from the terminal, wherein the live streaming video streams are video streams of the target terminal and the terminal in the interactive competition format.

In another aspect, a terminal is provided. The terminal includes: one or more processors; and one or more memories configured to store one or more instructions executable by the one or more processors. The one or more instructions, when executed by the one or more processors, cause the one or more processors to perform the method for displaying the interaction information according to any of the above aspects.

In another aspect, a storage medium storing one or more instructions is provided. The one or more instructions, when executed by one or more processors of a terminal, cause the terminal to perform the method for displaying the interaction information according to any one of the above aspects.

In another aspect, a computer program product is provided. The computer program product includes one or more instructions. The one or more instructions, when executed by one or more processors of a terminal, cause the terminal to perform the method for displaying the interaction information according to any one of the above aspects.

### BRIEF DESCRIPTION OF THE DRAWINGS

FIG. 1 shows a method for displaying interaction information according to an embodiment of the present disclosure;

FIG. 2 shows a flowchart of a method for displaying interaction information according to an embodiment of the present disclosure;

FIG. 3 shows a flowchart of another method for displaying interaction information according to an embodiment of the present disclosure;

FIG. 4 shows a flowchart of yet another method for displaying interaction information according to an embodiment of the present disclosure;

FIG. 5 shows a schematic diagram of a live streaming interface according to an embodiment of the present disclosure;

FIG. 6 shows a schematic diagram of another live streaming interface according to an embodiment of the present disclosure;

FIG. 7 shows a schematic diagram of yet another live streaming interface according to an embodiment of the present disclosure;

FIG. 8 shows a schematic diagram of still another live streaming interface according to an embodiment of the present disclosure;

FIG. 9 shows a schematic diagram of further another live streaming interface according to an embodiment of the present disclosure;

FIG. 10 shows a schematic diagram of yet still another live streaming interface according to an embodiment of the present disclosure;

FIG. 11 shows a logical structure block diagram of an apparatus for displaying interaction information according to an embodiment of the present disclosure;

FIG. 12 shows a logical structure block diagram of another apparatus for displaying interaction information according to an embodiment of the present disclosure; and

FIG. 13 shows a structural block diagram of a terminal according to an embodiment of the present disclosure.

### DETAILED DESCRIPTION

For a better understanding of the technical solutions of the present disclosure by persons of ordinary skill in the art, the technical solutions in the embodiments of the present disclosure are clearly and completely described in the following with reference to the accompanying drawings.

It is to be noted that terms “first”, “second”, and the like in the description and claims, as well as the above accompanying drawings, of the present disclosure are used for the purpose of distinguishing similar objects instead of indicating a particular order or sequence. It should be understood that data used in this way are interchangeable where appropriate, such that the embodiments of the present disclosure described herein can be implemented in an order other than those illustrated or described herein. The embodiments set forth in the following description of the all embodiments do not represent all embodiments consistent with the present disclosure. Instead, they are merely examples of apparatuses and methods consistent with aspects related to the present disclosure as recited in the appended claims.

User information involved in the present disclosure may be information authorized by a user or fully authorized by all parties.

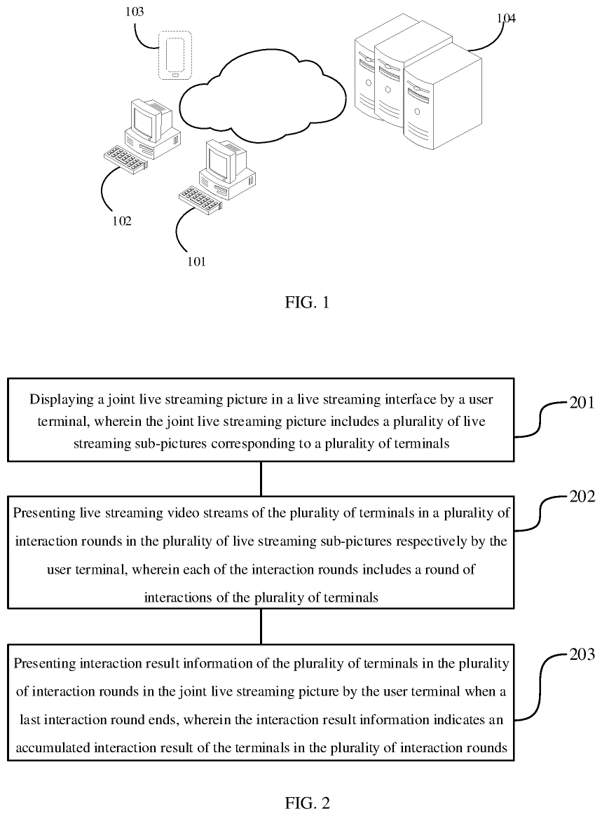

FIG. 1 shows a schematic diagram of an implementation environment of a method for displaying interaction information according to an embodiment of the present disclosure. Referring to FIG. 1, the implementation environment may include a first terminal 101, a second terminal 102, a third terminal 103, and a server 104. Each of the first terminal 101, the second terminal 102, and the third terminal 103 is an electronic device, which are described in detail as follows.

The first terminal 101 is mounted with and runs an application supporting a live streaming function. The application includes at least one of a live streaming application, a short video application, a social application or a game application. In some embodiments, the first terminal 101 is a terminal used by a first anchor. When the first anchor live-streams contents by using the first terminal 101, the first terminal 101 sends a live streaming video stream to the server 104 (commonly known as “stream pushing”). An audience acquires the live streaming video stream of the first terminal 101 by accessing the server 104 through the third terminal 103 (commonly known as “stream pulling”).

The second terminal 102 is mounted with and runs an application supporting a live streaming function. The application includes at least one of the live streaming application, the short video application, the social application or the game application. In some embodiments, the second terminal 102 is a terminal used by a second anchor. When the second anchor live-streams content by using the second terminal 102, the second terminal 102 pushes a stream to the server 104. The audience pulls the stream of the second terminal 102 by accessing the server 104 through the third terminal 103.

The third terminal 103 is mounted with and runs an application supporting a function of watching a live streaming. The application includes at least one of the live streaming application, the short video application, the social application or the game application. In some embodiments, the third terminal 103 is a terminal used by the audience. The audience sends a request to the server 104 for accessing the live streaming video stream of the terminal corresponding to either anchor by using the third terminal 103.

The first terminal 101, the second terminal 102 and the third terminal 103 are connected to the server 104 over a wireless or wired network.

The server 104 includes at least one of a server, a cluster of servers, a cloud computing platform, or a virtualization center. The server 104 is configured to provide background services for an application that supports a live streaming function or a function of watching a live streaming. In some embodiments, the server 104 is responsible for primary computation workload, and the first terminal 101, the second terminal 102, and the third terminal 103 are responsible for secondary computation workload; or, the server 104 is responsible for the secondary computation workload, and the first terminal 101, the second terminal 102 and the third terminal 103 are responsible for the primary computation workload; or, the first terminal 101, the second terminal 102, the third terminal 103 and the server 104 undertake computation workload collaboratively by adopting a distributed computation architecture.

In some embodiments, it is assumed that the first anchor and the second anchor live-stream content jointly (commonly known as “microphone-connected live streaming” or “microphone-connected live streaming competition”). The first anchor shoots a first live streaming video stream through the first terminal 101, and the first terminal 101 pushes the first live streaming video stream to the server 104 for caching. The second anchor shoots a second live streaming video stream through the second terminal 102, and the second terminal 102 pushes the second live streaming video stream to the server 104 for caching. The server 104 synthesizes a joint live streaming video stream by splicing the first live streaming video stream and the second live streaming video stream, and pushes the joint live streaming video stream to the third terminal 103 that accesses a live streaming room of either the first anchor or the second anchor, such that the audience can see a joint live streaming picture of the first anchor and the second anchor whether he or she visits the live streaming room of the first anchor or the live streaming room of the second anchor. The joint live streaming picture includes a first live streaming sub-picture and a second live streaming sub-picture. The first live streaming sub-picture displays the first live streaming video stream of the first anchor, and the second live streaming sub-picture displays the second live streaming video stream of the second anchor.

It should be noted that in the above example, joint live streaming by only two anchors is taken for illustration. In some embodiments, the number of anchors who live-stream content jointly is more than two. The embodiments of the present disclosure do not specifically limit the number of anchors who live-stream content jointly.

In some embodiments, the applications mounted on the first terminal 101, the second terminal 102 and the third terminal 103 are the same, or are the same type of the applications on different operating system platforms. Each of the first terminal 101, the second terminal 102 and the third terminal 103 may refer to one of the plurality of terminals. In this embodiment, the first terminal 101 of the first anchor, the second terminal 102 of the second anchor and the third terminal 103 of the audience are taken only as an example for illustration. Device types of the first terminal 101, the second terminal 102 and the third terminal 103 may be the same or different, and may include at least one of a smart phone, a tablet computer, an e-book reader, a moving picture experts group audio layer III (MP3) player, a moving picture experts group audio layer IV (MP4) player, a laptop portable computer or a desktop computer. For example, the first terminal 101, the second terminal 102 and the third terminal 103 may be smart phones or other handheld portable game devices. In the following embodiments, the terminal including a smart phone is taken as an example for illustration.

Those skilled in the art may know that the number of terminals may be more or less. For example, there may be only one terminal; or there may be dozens or hundreds of the terminals, or more. The embodiments of the present disclosure do not limit the number of terminals and the device types.

FIG. 2 shows a flowchart of a method for displaying interaction information according to an embodiment of the present disclosure. Referring to FIG. 2, the method for displaying the interaction information is applicable to a user terminal, and is described as follows.

In 201, the user terminal displays a joint live streaming picture in a live streaming interface, wherein the joint live streaming picture includes a plurality of live streaming sub-pictures corresponding to a plurality of terminals.

The user terminal may be the third terminal 103 held by the audience as exemplified in the above implementation environment, and the plurality of terminals may be the terminals (such as the first terminal 101 and the second terminal 102) held by the plurality of anchors as exemplified in the above embodiment.

In 202, the user terminal presents live streaming video streams of the plurality of terminals in a plurality of interaction rounds in the plurality of live streaming sub-pictures respectively, wherein each of the interaction rounds includes a round of interactions of the plurality of terminals.

In some embodiments, the user terminal plays, in each of the live streaming sub-pictures, the live streaming video stream of the terminal corresponding to the live streaming sub-picture in the plurality of interaction rounds, wherein each of the interaction rounds includes a round of interactions of the terminal.

A plurality of users may be a plurality of anchors, and the number of interaction rounds may be greater than or equal to 2, such as 3, 5, or the like.

In 203, the user terminal presents interaction result information of the plurality of terminals in the plurality of interaction rounds in the joint live streaming picture.

In some embodiments, the interaction result information is displayed in the joint live streaming picture by the user terminal in response to an end of the last interaction round, wherein the interaction result information indicates an accumulated interaction result of the terminals in the plurality of interaction rounds.

In some embodiments, the interaction result information includes Victory, Defeat, and Draw.

In some embodiments, the interaction result information is displayed as Victory in response to interaction results of the terminal being Victory in more than half of the interaction rounds; or, the interaction result information is displayed as Defeat in response to interaction results of the terminal being Defeat in more than half of the interaction rounds; or, the interaction result information is displayed as Draw in response to interaction results of the terminal being Victory in half of the interaction rounds.

In some embodiments, the method further includes: displaying interaction score information of the terminal in any one of the interaction rounds in the joint live streaming picture, wherein the interaction score information in the plurality of interaction rounds is intended to determine the interaction result information.

In some embodiments, displaying the interaction score information of the terminal in any one of the interaction rounds in the joint live streaming picture includes: dynamically displaying the interaction score information of the terminal in a strip form in each of the live streaming sub-pictures corresponding to the terminal.

In some embodiments, displaying the interaction score information of the terminal in any one of the interaction rounds in the joint live streaming picture includes: displaying a target strip in the joint live streaming picture, wherein the target strip includes a plurality of segments each representing the interaction score information of the terminal in the interaction round.

In some embodiments, displaying the interaction score information of the terminal in any one of the interaction rounds in the joint live streaming picture includes: adding an interactive special effect to the interaction score information in the joint live streaming picture within a target time period before an end time of the interaction rounds, wherein the interactive special effect indicates that accumulation of the interaction score information stops after the target time period.

In some embodiments, the method further includes: playing a start animation for any one of the interaction rounds at a start time of the interaction round, wherein the start animation indicates that the interaction round starts; and playing an end animation for the interaction round at an end time of the interaction round, wherein the end animation indicates that the interaction round ends.

All of the above optional technical solutions may form other optional embodiments of the present disclosure in an arbitrary combination thereof, and the description thereof is not repeated herein.

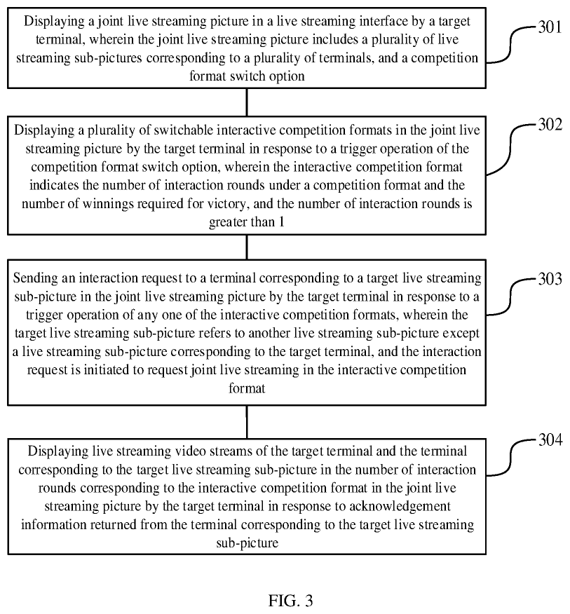

FIG. 3 shows a flowchart of another method for displaying interaction information according to an embodiment of the present disclosure. Referring to FIG. 3, the method is applicable to a target terminal, and is described as follows.

In 301, the target terminal displays a joint live streaming picture in a live streaming interface, wherein the joint live streaming picture includes a plurality of live streaming sub-pictures corresponding to a plurality of terminals, and a competition format switch option.

The target terminal may be the first terminal 101 held by the first anchor as exemplified in the above implementation environment, and the plurality of terminals may be the terminals (such as the first terminal 101 and the second terminal 102) held by the plurality of anchors as exemplified in the above embodiment.

It can be seen that as the target terminal participates in the joint live streaming process, the target terminal is included in the plurality of terminals. That is, the joint live streaming picture includes a live streaming sub-picture corresponding to the live streaming video stream shot by the target terminal itself. Taking the joint live streaming of two anchors as an example, the first terminal 101 of the first anchor displays a joint live streaming picture in the live streaming interface, wherein the joint live streaming picture includes the first live streaming sub-picture corresponding to the first terminal 101, the second live streaming sub-picture corresponding to the second terminal 102, and the competition format switch option.

In 302, the target terminal displays a plurality of switchable interactive competition formats in the joint live streaming picture in response to a trigger operation of the competition format switch option, wherein the interactive competition format indicates the number of interaction rounds under a competition format and the number of winnings required for victory; and the number of interaction rounds is greater than 1.

In some embodiments, the interactive competition format indicates the number of interaction rounds under a competition format and the number of winnings required for victory.

In some embodiments, the interactive competition format may include a best-of-three format, a best-of-five format, and the like.

In 303, the target terminal sends an interaction request to a terminal corresponding to a target live streaming sub-picture in the joint live streaming picture in response to a trigger operation of any one of the interactive competition formats, wherein the target live streaming sub-picture refers to another live streaming sub-picture except a live streaming sub-picture corresponding to the target terminal, and the interaction request is initiated to request joint live streaming in the interactive competition format.

In some embodiments, the interaction request is sent to the terminal by the target terminal in response to the trigger operation of any one of the interactive competition formats, wherein the terminal corresponds to the target live streaming sub-picture, the target live streaming sub-picture includes a live streaming sub-picture except the live streaming sub-picture corresponding to the target terminal, and the interaction request is initiated to request the joint live streaming in the interactive competition format.

Taking the joint live streaming of two anchors as an example, in the case that the current terminal (target terminal) is the first terminal 101 of the first anchor, as the first terminal 101 corresponds to the first live streaming sub-picture, and the joint live streaming picture includes the first live streaming sub-picture and the second live streaming sub-picture, the target live streaming sub-picture is the second live streaming sub-picture, and the second live streaming sub-picture corresponds to the second terminal 102. Thus, the terminal corresponding to the target live streaming sub-picture is the second terminal 102 of the second anchor.

In the above process, the target terminal may send the interaction request to the server. The interaction request is initiated to request the joint live streaming with the terminal corresponding to the target live streaming sub-picture in the interactive competition format. The server forwards the interaction request to the terminal corresponding to the target live streaming sub-picture.

In 304, the target terminal displays live streaming video streams of the target terminal and the terminal corresponding to the target live streaming sub-picture in the number of interaction rounds corresponding to the interactive competition format in the joint live streaming picture in response to acknowledgement information returned from the terminal corresponding to the target live streaming sub-picture.

In some embodiments, the live streaming video streams are displayed in the joint live streaming picture by the target terminal in response to the acknowledgement information returned from the terminal, wherein the live streaming video streams are video streams of the target terminal and the terminal in the interactive competition format.

In the above process, the terminal corresponding to the target live streaming sub-picture may return the acknowledgement information to the server. The acknowledgement information indicates that the terminal determines to live-streams content jointly with the target terminal in the interactive competition format. The server forwards the acknowledgement information to the target terminal.

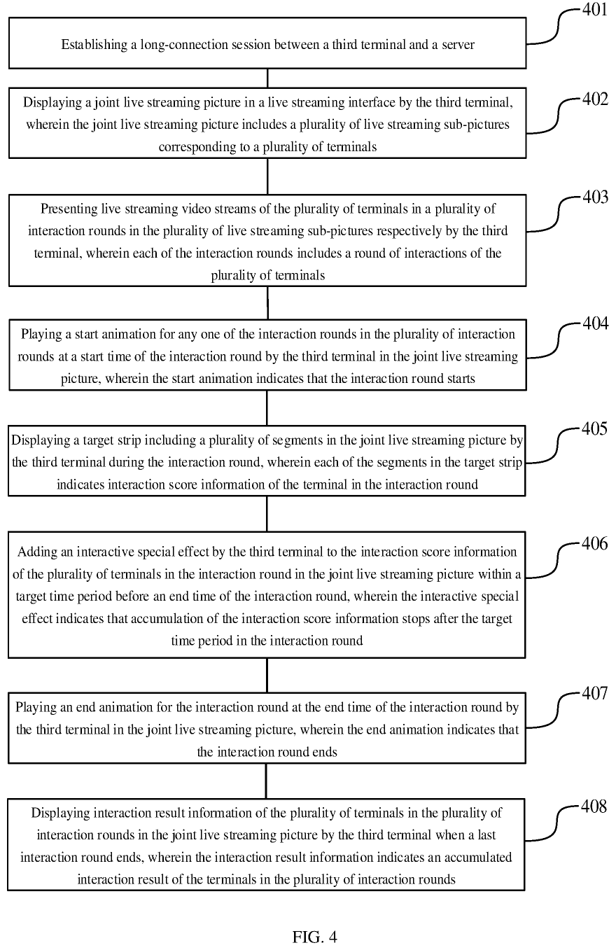

FIG. 4 shows a flowchart of yet another method for displaying interaction information according to an embodiment of the present disclosure. Referring to FIG. 4, the method is applicable to a third terminal, and is described as follows.

In 401, the third terminal establishes a long-connection session between the third terminal and a server.

In some embodiments, the long-connection session includes a network session based on a Hypertext Transfer Protocol (HTTP) connection, a network session based on a Real-Time Messaging Protocol (RTMP) connection, or the like. The long-connection session may be commonly called “a long-connection channel.”

The long-connection session may be configured to transmit interaction score information in a plurality of interaction rounds and final interaction result information. For example, after the audience gives a virtual gift to any anchor participating in the joint live streaming, the server updates the interaction score information in the current interaction round for the anchor who receives the virtual gift based on the gift-giving behavior of the audience, and issues the updated interaction score information to the third terminal through the long-connection session.

In 402, the third terminal displays a joint live streaming picture in a live streaming interface, wherein the joint live streaming picture includes a plurality of live streaming sub-pictures corresponding to a plurality of terminals.

The plurality of terminals may be the terminals (such as the first terminal 101 and the second terminal 102) held by the plurality of anchors as exemplified in the above embodiments. It should be noted that in the embodiments of the present disclosure, joint live streaming of two anchors is taken as an example for illustration. In some embodiments, the number of anchors participating in the joint live streaming may be three, four, or more. The embodiments of the present disclosure do not specifically limit the number of anchors participating in the joint live streaming.

In the above process, the joint live streaming of two anchors is taken as an example for illustration. The first anchor pushes the first live streaming video stream shot by the first terminal to the server. The second anchor pushes the second live streaming video stream shot by the second terminal to the server. The audience can initiate an access request for a joint live streaming picture to the server by tapping a link of a first live streaming room of the first anchor, a link of a second live streaming room of the second anchor or a joint live streaming link of the two anchors on the third terminal. The server splices the first live streaming video stream of the first anchor and the second live streaming video stream of the second anchor into a joint live streaming video stream in response to the access request, and returns the joint live streaming video stream to the third terminal, wherein the joint live streaming video stream displays the joint live streaming picture. The third terminal displays the joint live streaming picture by playing the joint live streaming video stream in a live streaming interface of an application after receiving the joint live streaming video stream.

In some embodiments, the audience may not have any social relationship with the two anchors, or may have a one-way or two-way relationship with the two anchors. For example, the audience follows the first or second anchor, or the audience and the first or second anchor follow each other.

In 403, the third terminal presents live streaming video streams of the plurality of terminals in a plurality of interaction rounds in the plurality of live streaming sub-pictures respectively, wherein each of the interaction rounds includes a round of interactions of the plurality of terminals.

In some embodiments, the third terminal plays, in each of the live streaming sub-pictures, the live streaming video streams of the terminal corresponding to the live streaming sub-picture in the plurality of interaction rounds, wherein each of the interaction rounds includes a round of interactions of the terminal.

The live streaming video streams of the plurality of terminals in the plurality of interaction rounds may be live streaming video streams of the anchors corresponding to the plurality of terminals in the plurality of interaction rounds, or may be live streaming recording video streams of game anchors corresponding to the plurality of terminals in the plurality of interaction rounds. The number of interaction rounds may be greater than or equal to 2, such as 3, 5, or the like.

In the above process, the third terminal receives the joint live streaming video stream of a plurality of users (namely, a plurality of anchors) through the established long-connection session with the server, wherein the joint live streaming video stream is spliced by live streaming video streams of the plurality of anchors in the plurality of interaction rounds. The third terminal only needs to present the live streaming video streams of the corresponding anchors in the plurality of interaction rounds in the corresponding live streaming sub-pictures respectively.

In 404, the third terminal plays a start animation for any one of the interaction rounds in the plurality of interaction rounds at a start time of the interaction round in the joint live streaming picture, wherein the start animation indicates that the interaction round starts.

In some embodiments, the start animation for any one of the interaction rounds is played at the start time of the interaction round by the third terminal in the joint live streaming picture.

The start animation may be a resource issued by the server to the third terminal in real time in the long-connection session, or may be a resource pre-stored in a local buffer area of the third terminal. The embodiments of the present disclosure do not specifically limit acquisition of the start animation.

In some embodiments, the third terminal maintains a timer (either count-up or count-down) for each of the interaction rounds. After the timer shows that a previous interaction round has reached a duration, if the previous interaction round is not a last interaction round in the interactive competition format, the third terminal determines that the interaction round starts, and plays the start animation for the interaction round in the joint live streaming picture.

It should be noted that the start time of the interaction round may be equal to or later than the end time of the previous interaction round, and a time difference between them may be equal to an interval time which may be set by the server. For example, the interval time may be 5 seconds, in which both final interaction score information and an interaction result of each anchor in the previous interaction round may be displayed.

In some embodiments, the server maintains a timer. After the timer shows that a previous interaction round has reached a duration, if the previous interaction round is not the last interaction round in the interactive competition format, the server determines that the interaction round starts, and issues the start animation for the interaction round to the third terminal in the long-connection session, such that the terminal displays an interaction animation in the joint live streaming picture after receiving the start animation. In some embodiments, the start animations of different interaction rounds may be the same or different. The embodiments of the present disclosure do not specifically limit the content of the start animation.

In some embodiments, the terminal may display the start animation in a central area of the joint live streaming picture; or, a user may customize a display area for the start animation; or, the user may disable a display option of the start animation in settings of a live streaming application, such that the third terminal does not display the start animation at the start time of each interaction round.

In 405, the third terminal displays a target strip including a plurality of segments in the joint live streaming picture during the interaction round, wherein each of the segments in the target strip indicates interaction score information of the terminal in the interaction round.

In some embodiments, the target strip is displayed in the joint live streaming picture by the third terminal, wherein the target strip includes the plurality of segments each representing the interaction score information of the terminal in the interaction round.

In some embodiments, the target strip may span all live streaming sub-pictures in the joint live streaming picture. At this time, each segment indicates the interaction score information of the anchor corresponding to the live streaming sub-picture with the largest coverage in the segment during the interaction round. The longer the segment is, the higher the interaction score of the anchor corresponding to the segment is.

In some embodiments, the third terminal receives the interaction score information of the plurality of anchors in the interaction round through the established long-connection session with the server. As the interaction score information of each anchor in the interaction round is updated in real time according to an interaction behavior of the audience, the server can maintain the existing interaction score information of each anchor. In response to receiving an interaction instruction from the audience for any anchor every time, the server updates the interaction score information of the anchor specified by the interaction instruction. In addition, the server can periodically issue the latest interaction score information to the third terminal in the long-connection session, such that the third terminal displays a process that each segment of the target strip changes from an original length to a latest length in the joint live streaming picture based on the latest interaction score information, wherein the latest length refers to the length corresponding to the latest interaction score information.

In some embodiments, a length ratio of the segments is equal to a latest interaction score ratio of the anchors. In some embodiments, different segments may have different display modes, for example, different colors, or different transparencies, or different soft light effects, or the like. The embodiments of the present disclosure do not specifically limit the display mode of each segment.

In some embodiments, the third terminal sets a waiting time. Once no new interaction score information is received beyond the waiting time in the interaction round in the long-connection session, the third terminal sends an interaction score acquisition request to the server in the long-connection session, such that the server returns the latest interaction score information to the third terminal in response to the interaction score acquisition request. In some embodiments, the waiting time may have any value greater than or equal to 0, for example, 15 seconds.

In some embodiments, the interaction instruction can specify an interaction behavior and the number of interaction(s). For example, if the interaction behavior is that a virtual gift is given to an anchor and the number of interactions is 5, the audience has given the virtual gifts to the anchor for five times.

In some embodiments, in the process of updating the interaction score information based on the interaction instruction, the server maps the number of interaction(s) in the interaction instruction to an interaction score increment, and uses a sum (namely, a value acquired by adding the following two) of a value of an existing interaction score information of the anchor and a value of the interaction score increment as updated interaction score information. A mapping relationship between the number of interaction(s) and the interaction score increment may also be related to the type of a virtual item. Different types of virtual items may have different mapping relationships.

For example, if giving a virtual gift A once may increase the interaction score for the anchor by 10 scores and giving a virtual gift B once may increase the interaction score for the anchor by 20 scores, assuming that the audience gives the anchor 5 virtual gifts A and 1 virtual gift B during the interaction round, the interaction score for the anchor can be increased by 70 scores totally. That is, the interaction score increment is equal to 70 scores.

In some embodiments, the third terminal displays the latest interaction score information of the corresponding anchor at present in a first target area of each segment of the target strip in a text form. For example, the first target area may be an upper area of each segment, or may be an inner edge area of each segment, or the like.

In 405, the third terminal displays the interaction score information of the plurality of terminals in any one of the interaction rounds in the joint live streaming picture during the interaction round, wherein the interaction score information of the plurality of interaction rounds is intended to determine the final interaction result information. In this case, the third terminal presents the interaction score information of each anchor in the form of a whole target strip.

In some embodiments, 405 may be further practiced as follows: in any one of the live streaming sub-pictures of the joint live streaming picture, the third terminal dynamically presents the interaction score information of the terminal in the interaction round in a strip form. That is, the third terminal dynamically displays the interaction score information of the terminal in the strip form in each of the live streaming sub-pictures. In this case, the third terminal displays a separate strip for each anchor in his or her live streaming sub-picture, wherein the length ratio between different strips may be equal to the latest interaction score ratio between different anchors.

In some embodiments, the third terminal displays the latest interaction score information of the corresponding anchor at present in a second target area of each strip in a text form. For example, the second target area may be an upper area of each strip, or may be a lower area of each strip, or the like.

In the mode of displaying the interaction score information based on the strip form, a process of acquiring the latest interaction score information is similar to that in the above embodiment (i.e., displaying the interaction score information based on the target strip), which is thus not repeated herein.

In 406, the third terminal adds an interactive special effect to the interaction score information of the plurality of terminals.

In some embodiments, the third terminal adds the interactive special effect to the interaction score information in the joint live streaming picture within the target time period before the end time of the interaction rounds, wherein the interactive special effect indicates that accumulation of the interaction score information stops after the target time period.

The target time period may be any time period longer than or equal to 0, for example, 30 seconds.

In some embodiments, the interactive special effect may be a special effect of spark. In the case that the interaction score information of each anchor is displayed in the target strip, the third terminal adds the special effect of spark to each segment of the target strip. In the case that the interaction score information of each anchor is displayed in a plurality of strips, the third terminal adds the special effect of spark to each strip. In some embodiments, the interactive special effect may also be a special effect of magnification, a special effect of soft light, a special effect of color deepening, or the like. The embodiments of the present disclosure do not specifically limit the type of the interactive special effect.

In some embodiments, the interactive special effect is a resource issued by the server to the third terminal in real time in the long-connection session, or may be a resource pre-stored in the local buffer area of the third terminal. The embodiments of the present disclosure do not specifically limit acquisition of the interactive special effect.

In the above process, the third terminal may maintain a timer (either count-up or count-down) for each of the interaction rounds. After the timer shows that the target time period is left before an end time of the interaction rounds, the third terminal adds the interactive special effect to the interaction score information of the plurality of anchors in the interaction round in the joint live streaming picture.

In some embodiments, the server maintains a timer. After the timer shows that the target time period is left before the end time of the interaction rounds, the server issues the interactive special effect to the third terminal in the long-connection session, such that the third terminal adds the interactive special effect to the interaction score information of the plurality of anchors in the interaction round in the joint live streaming picture after receiving the interactive special effect. In some embodiments, interactive special effects corresponding to the interaction score information of different anchors may be the same or different. The embodiments of the present disclosure do not specifically limit the content of the interactive special effect.

In 407, the third terminal plays an end animation for the interaction round at an end time of the interaction round in the joint live streaming picture, wherein the end animation indicates that the interaction round ends.

In some embodiments, the end animation is a resource issued by the server to the third terminal in real time in the long-connection session, or may be a resource pre-stored in the local buffer area of the third terminal. The embodiments of the present disclosure do not specifically limit acquisition of the end animation.

In some embodiments, the third terminal maintains a timer (either count-up or count-down) for each of the interaction rounds. After the timer shows that the interaction round has reached a duration, the third terminal determines that the interaction round ends, and plays the end animation for the interaction round in the joint live streaming picture.

In some embodiments, the server maintains a timer. After the timer shows that the interaction round has reached a duration, the server determines that the interaction round ends, and issues the end animation for the interaction round to the third terminal in the long-connection session, such that the terminal displays an interaction animation in the joint live streaming picture after receiving the end animation. In some embodiments, the end animations of different interaction rounds may be the same or different. The embodiments of the present disclosure do not specifically limit the content of the end animation.

In some embodiments, the terminal may display the end animation in the central area of the joint live streaming picture; or, a user may customize a display area for the end animation; or, the user may disable a display option of the end animation in the settings of the live streaming application, such that the third terminal does not display the end animation at the end time of each interaction round.

In 408, the third terminal displays interaction result information of the plurality of terminals in the plurality of interaction rounds.

In some embodiments, the third terminal displays the interaction result information in the joint live streaming picture in response to an end of the last interaction round, wherein the interaction result information indicates an accumulated interaction result of the terminals in the plurality of interaction rounds.

In the above process, the third terminal may receive the interaction result information of the plurality of anchors in the plurality of interaction rounds in the established long-connection session with the server, wherein the interaction result information may include Victory, Defeat, and Draw.

In some embodiments, in a process of presenting the interaction result information, the third terminal displays Victory in the joint live streaming picture in response to interaction results of any one of the terminals being Victory in more than half of the interaction rounds; or, the third terminal displays Defeat in the joint live streaming picture in response to interaction results of any one of the terminals being Defeat in more than half of the interaction rounds. Otherwise, the third terminal displays Draw in the joint live streaming picture.

In other words, the interaction result information is displayed as Victory in response to the interaction results of the terminal being Victory in more than half of the interaction rounds; or, the interaction result information is displayed as Defeat in response to the interaction results of the terminal being Defeat in more than half of the interaction rounds; or, the interaction result information is displayed as Draw in response to the interaction results of the terminal being Victory in half of the interaction rounds.

In some embodiments, if the number of winnings of any anchor in the plurality of interaction rounds is greater than that of losings, the interaction result information of the anchor is determined as Victory. If the number of winnings of any anchor in the plurality of interaction rounds is less than that of losings, the interaction result information of the anchor is determined as Defeat. If the number of winnings of any anchor in the plurality of interaction rounds is equal to that of losings, the interaction result information of the anchor is determined as Draw.

All of the above optional technical solutions may form other optional embodiments of the present disclosure in an arbitrary combination thereof, and the description thereof is not repeated herein.

In the above embodiments, how the third terminal displays the joint live streaming picture based on the plurality of interaction rounds in a process that the audience watches the joint live streaming through the third terminal is introduced. In this embodiment of the present disclosure, joint live streaming of two anchors is taken as an example for illustration, and live streaming interfaces for anchor terminals and an audience terminal are presented respectively in combination with a plurality of interface diagrams.

First, the first anchor taps the competition format switch option on the joint live streaming picture of the first terminal.

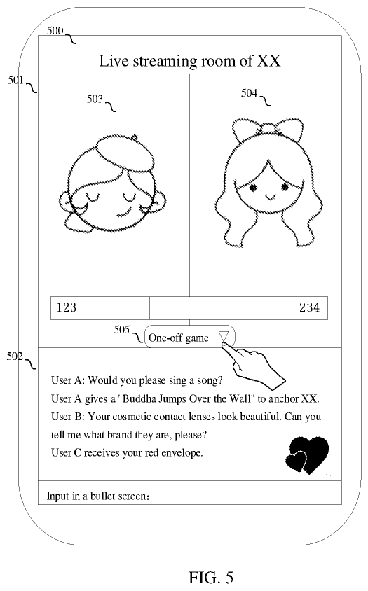

FIG. 5 shows a schematic diagram of a live streaming interface 500 according to an embodiment of the present disclosure. As shown in FIG. 5, the live streaming interface 500 includes a joint live streaming picture 501 and a comment area 502. The joint live streaming picture 501 includes a first live streaming sub-picture 503 of a first anchor and a second live streaming sub-picture 504 of a second anchor, and further includes a competition format switch option 505. The first anchor can switch from a current interactive competition format to another interactive competition format by tapping the competition format switch option 505. For example, the current interactive competition format being a one-off game is taken as an example for illustration.

Second, the first terminal displays a plurality of switchable interactive competition formats in the joint live streaming picture in response to the tap operation of the first anchor on the competition format switch option.

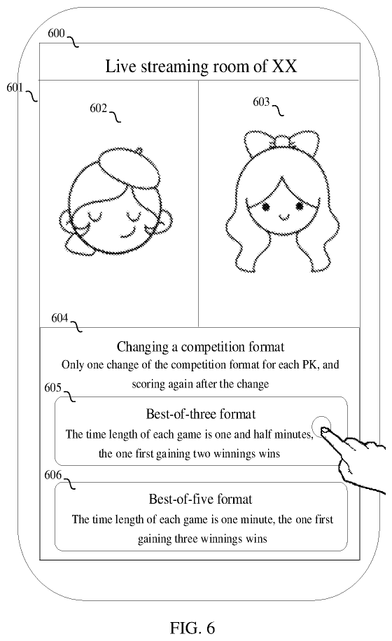

FIG. 6 shows a schematic diagram of another live streaming interface 600 according to an embodiment of the present disclosure. As shown in FIG. 6, the live streaming interface 600 includes a joint live streaming picture 601 which includes a first live streaming sub-picture 602 of the first anchor and a second live streaming sub-picture 603 of the second anchor. An interaction panel 604 pops up in the joint live streaming picture 601 by the first terminal in response to the tap operation of the first anchor on the competition format switch option, and a plurality of switchable interactive competition formats 605 and 606 are displayed on the interaction panel 604. Assuming that the current interactive competition format is a one-off game, the switchable interactive competition format 605 may be a best-of-three format. In the best-of-three format, a time length of each game is one and half minutes, the one first gaining two winnings wins (or the one with the highest accumulated total score after the end of the three games wins). The switchable interactive competition format 606 may be a best-of-five format. In the best-of-five format, a time length of each game is one minute, the one first gaining three winnings wins (or the one with the highest accumulated total score after the end of the five games wins). The term “time length of each game” here also refers to “the duration of each interaction round.” In addition, prompt information such as “only one change of the competition format for each PK, and scoring again after the change” may be displayed on the interaction panel 604, and one PK refers to one interaction round.

Third, the first anchor taps the interactive competition format to be switched on the first terminal.

Fourth, the first terminal sends an interaction request to the second terminal of the second anchor in response to the tap operation of the first anchor on any one of the interactive competition formats, wherein the interaction request is initiated to request joint live streaming in the interactive competition format.

In the above process, long-connection sessions are established between the first terminal and the server and between the second terminal and the server respectively. The first terminal can send the interaction request to the server through the long-connection session, wherein the interaction request carries a user identification of the second anchor and the interactive competition format. The server locates the second terminal through the user identification of the second anchor, and forwards the interaction request to the second terminal through the long-connection session.

Fifth, the second anchor taps a YES option of the interaction request on the second terminal.

Sixth, the server clears the interaction score information of the first anchor and the second anchor under the current interactive competition format, and re-accumulates the interaction score information of each anchor under the new interactive competition format.

In the above process, the new interactive competition format can be entered after the two anchors agree. When the new competition format starts, the original interaction score information is cleared and re-scoring is started.

Seventh, the audience accesses the first live streaming room of the first anchor through the third terminal, and the joint live streaming picture of the two anchors based on the new interactive competition format is displayed.

In the above process, a long-connection session (namely, a long-connection data channel) is maintained between the third terminal and the server, such that the server can actively issue the latest scores of the two anchors to the third terminal during the game. After the audience performs interaction behaviors such as giving a virtual gift, giving a like, and sending a bullet screen to either anchor, the server calculates the latest score for each anchor and sends the latest score to the third terminal through the long-connection session. The third terminal displays a length change process of the target strip based on the latest score of each anchor.

In some embodiments, the third terminal and the server can respectively maintain a state machine to ensure that a game flow jumps orderly in an initialization state, a connecting state, a connected state, an in-game state, a game end state, and a penalty state. State synchronization between the third terminal and the server is realized through the long-connection session. By maintaining the state machines, the third terminal can be prevented from displaying a disordered message. For example, as the interaction score information in the first interaction round may reach the second terminal later than the interaction result information in the first interaction round reaching the second terminal due to network delay, the second terminal does not process the interaction result information in the long-connection session because the state of the second terminal is set to “in-game state” at this time, but waits until the interaction score information in the first interaction round is displayed. After displaying the interaction score information, the second terminal switches the “in-game state” to the “game end state” if the timer shows that the duration of the first interaction round has been reached, and then processes the interaction result information. Thus, it ensures that the relevant information of the whole joint live streaming in each interaction round is displayed orderly.

It should be noted that the process of displaying the joint live streaming picture by the first terminal or the second terminal is similar to that of the third terminal, which is not repeated herein. In short, the client (such as the first terminal, the second terminal and the third terminal) generates a corresponding message after receiving a network request, long-connection channel data, a User Tap, or a client timing task, and sends the message to the state machine. The state machine determines whether to jump to the next state based on the current state and the content of the message, and displays a corresponding interface change on the client, wherein the interface change includes, for example, scoring bar (referring to the target strip or a plurality of strips) update, scoreboard update, countdown, a start animation and an end animation for each game, or the like.

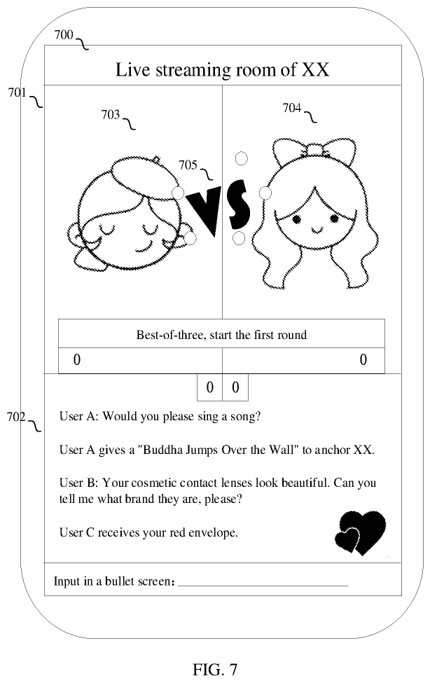

In some embodiments, the third terminal may play the start animation at the start time of each interaction round under the new interactive competition format. FIG. 7 shows a schematic diagram of yet another live streaming interface 700 according to an embodiment of the present disclosure. As shown in FIG. 7, the live streaming interface 700 includes a joint live streaming picture 701 and a comment area 702. The joint live streaming picture 701 includes a first live streaming sub-picture 703 of the first anchor and a second live streaming sub-picture 704 of the second anchor. Assuming that the new interactive competition format is the best-of-three format, at the start time of each game, the start animation 705 is played in the central area of the joint live streaming picture 701. For example, the start animation 705 includes a floating effect of “VS” in the center of the screen and a prompt message of “best-of-three, start the first round.”

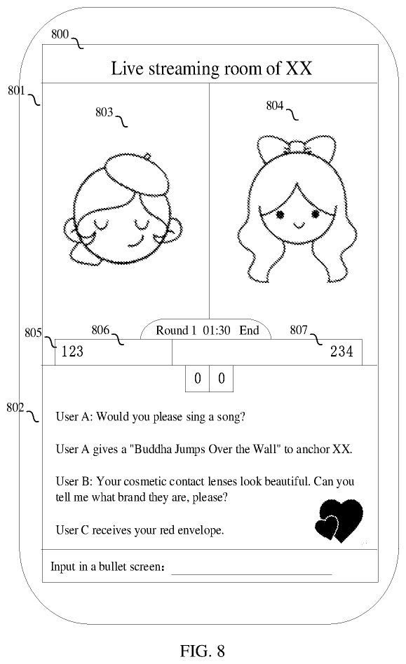

In some embodiments, the third terminal displays a target strip including a plurality of segments in the joint live streaming picture, and each segment in the target strip indicates the interaction score information of an anchor in the current interaction round. FIG. 8 shows a schematic diagram of still another live streaming interface 800 according to an embodiment of the present disclosure. As shown in FIG. 8, the live streaming interface 800 includes a joint live streaming picture 801 and a comment area 802. The joint live streaming picture 801 includes a first live streaming sub-picture 803 of the first anchor and a second live streaming sub-picture 804 of the second anchor. Assuming that the new interactive competition format is the best-of-three format, in the first interaction round, the target strip 805 is displayed to indicate interaction score information of the first anchor and interaction score information of the second anchor respectively. The target strip 805 includes a first segment 806 and a second segment 807. The first segment 806 may indicate the interaction score information (assuming 123 scores) of the first anchor in the first interaction round at present, and the second segment 807 may indicate the interaction score information (assuming 234 scores) of the second anchor in the first interaction round at present. It can be seen that since the interaction score information of the second anchor is higher than that of the first anchor, the second segment 807 is obviously longer than the first segment 806.

In some embodiments, the third terminal may play an end animation at the end time of each interaction round under the new interactive competition format, wherein the end animation may be configured to indicate the interaction result information of each anchor in the current interaction round.

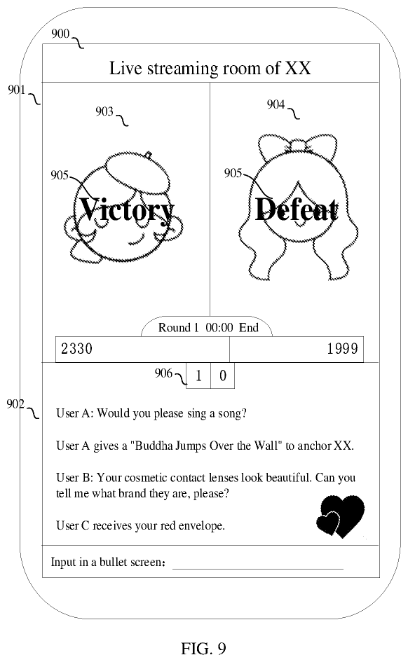

FIG. 9 shows a schematic diagram of further another live streaming interface 900 according to an embodiment of the present disclosure. As shown in FIG. 9, the live streaming interface 900 includes a joint live streaming picture 901 and a comment area 902. The joint live streaming picture 901 includes a first live streaming sub-picture 903 of the first anchor and a second live streaming sub-picture 904 of the second anchor. Assuming that the new interactive competition format is the best-of-three format, as at the end time of the first interaction round, the interaction score information of the first anchor is 2330 scores, and the interaction score information of the second anchor is 1999 scores, the first anchor wins in the first interaction round because the interaction score of the first anchor is higher. At this time, the end animation 905 may be played on the joint live streaming picture 901, and may be configured to publish the interaction result information of the first anchor and the interaction result information of the second anchor respectively in the first interaction round. For example, “Victory” is displayed in the first live streaming sub-picture 903 of the first anchor, and “Defeat” is displayed in the second live streaming sub-picture 904 of the second anchor. Further, a scoreboard 906 of the new interactive competition format may be displayed in the joint live streaming picture, and is set to“1:0.”

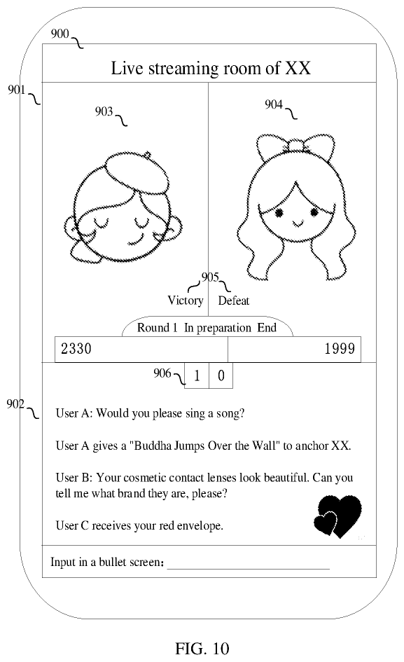

FIG. 10 shows a schematic diagram of yet still another live streaming interface 900 according to an embodiment of the present disclosure. As shown in FIG. 10, the live streaming interface 900 includes the joint live streaming picture 901 and the comment area 902. The joint live streaming picture 901 includes the first live streaming sub-picture 903 of the first anchor and the second live streaming sub-picture 904 of the second anchor. Assuming that the new interactive competition format is the best-of-three format, as at the end time of the first interaction round, the interaction score information of the first anchor is 2330 scores, and the interaction score information of the second anchor is 1999 scores, the first anchor wins in the first interaction round because the interaction score of the first anchor is higher. At this time, the end animation 905 may be played on the joint live streaming picture 901, and may be configured to publish the interaction result information of the first anchor and the interaction result information of the second anchor in the first interaction round. FIG. 9 shows the schematic diagram of the interface at the beginning of the playing of the end animation 905, while FIG. 10 shows the schematic diagram of the interface near the end of the playing of the end animation 905. It can be seen that an animation effect of the end animation 905 is to display the interaction result information of each anchor in the current interaction round in the central area of the live streaming sub-picture of the anchor, and to gradually downsize the interaction result information and to move it to a corner area of the live streaming sub-picture.

In the above process, at the beginning of each interaction round, the third terminal actually plays the end animation of the previous interaction round and the start animation of the current interaction round. Specifically, the state machine may instruct a user interface (UI) processing module to play the end animation of the previous interaction round and the start animation of the current interaction round, and meanwhile to clear a scoring bar (referring to the target strip or a plurality of strips), displayed scores, or the like.

In some embodiments, the third terminal may also determine whether 30 seconds before the end time of the current interaction round is reached according to the countdown of the current interaction round; and if yes, the interactive special effect such as spark may be displayed on the scoring bar.

For example, assuming that in the one-off game format, the time length of one game is 5 minutes, the audience gift giving peak is concentrated in the decisive moment of the final 30 seconds in the 5-minute microphone-connected live streaming of the two anchors. While in the best-of-three format, the whole 5-minute competition is divided into three one-and-half-minute interaction rounds; or, in the best-of-five format, the whole 5-minute competition is divided into five one-minute interaction rounds.

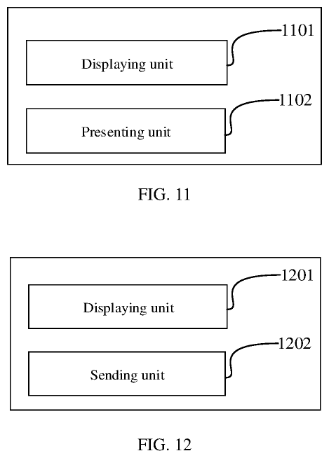

FIG. 11 shows a logical structure block diagram of an apparatus for displaying interaction information according to an embodiment of the present disclosure. Referring to FIG. 11, the apparatus includes a displaying unit 1101 and a presenting unit 1102.

The displaying unit 1101 is configured to display a joint live streaming picture in a live streaming interface, wherein the joint live streaming picture includes a plurality of live streaming sub-pictures corresponding to a plurality of terminals. That is, the joint live streaming picture includes the plurality of live streaming sub-pictures.

The presenting unit 1102 is configured to present, in the plurality of live streaming sub-pictures, live streaming video streams of the plurality of terminals in a plurality of interaction rounds respectively, wherein each of the interaction rounds includes a round of interactions of the terminals. In some embodiments, the presenting unit 1102 is configured to play, in each of the live streaming sub-pictures, the live streaming video streams of the terminal corresponding to the live streaming sub-picture in the plurality of interaction rounds, wherein each of the interaction rounds includes a round of interactions of the terminal.

The presenting unit 1102 is further configured to present interaction result information of the plurality of the terminals in the plurality of interaction rounds in the joint live streaming picture. In some embodiments, the presenting unit 1102 is further configured to display the interaction result information in the joint live streaming picture in response to an end of the last interaction round, wherein the interaction result information indicates an accumulated interaction result of the terminals in the plurality of interaction rounds.

In some embodiments, the interaction result information is displayed as Victory in response to interaction results of the terminal being Victory in more than half of the interaction rounds; or the interaction result information is displayed as Defeat in response to interaction results of the terminal being Defeat in more than half of the interaction rounds; or the interaction result information is displayed as Draw in response to interaction results of the terminal being Victory in half of the interaction rounds.

In some embodiments, the presenting unit 1102 is further configured to display interaction score information of the terminal in any one of the interaction rounds in the joint live streaming picture, wherein the interaction score information in the plurality of interaction rounds is intended to determine the interaction result information.

In some embodiments, the presenting unit 1102 is further configured to dynamically display the interaction score information of the terminal in a strip form in each of the live streaming sub-pictures.

In some embodiments, the presenting unit 1102 is further configured to display a target strip in the joint live streaming picture, wherein the target strip includes a plurality of segments each representing the interaction score information of the terminal in the interaction round.

In some embodiments, the presenting unit 1102 is further configured to add an interactive special effect to the interaction score information in the joint live streaming picture within a target time period before an end time of the interaction rounds, wherein the interactive special effect indicates that accumulation of the interaction score information stops after the target time period.

In some embodiments, based on the apparatus structure of FIG. 11, the apparatus further includes: a playing unit, configured to play a start animation for any one of the interaction rounds at a start time of the interaction round, wherein the start animation indicates that the interaction round starts. The playing unit is further configured to play an end animation for the interaction round at an end time of the interaction round, wherein the end animation indicates that the interaction round ends.

All of the above optional technical solutions may form other optional embodiments of the present disclosure in an arbitrary combination thereof, and the description thereof is not repeated herein.

With regard to the apparatus in the above embodiment, the details about performing the operations by the respective units have been described in detail in the embodiments of the related method for displaying the interaction information, which are not described in detail herein.

FIG. 12 shows a logical structure block diagram of another apparatus for displaying interaction information according to an embodiment of the present disclosure. Referring to FIG. 12, the apparatus includes a displaying unit 1201 and a sending unit 1202.

The displaying unit 1201 is configured to display a joint live streaming picture in a live streaming interface, wherein the joint live streaming picture includes a plurality of live streaming sub-pictures and a competition format switch option.

The displaying unit 1201 is further configured to display a plurality of switchable interactive competition formats in the joint live streaming picture in response to a trigger operation of the competition format switch option, wherein the interactive competition format indicates the number of interaction rounds under a competition format and the number of winnings required for victory, and the number of interaction rounds is greater than 1.

The sending unit 1202 is configured to send an interaction request to a terminal in response to a trigger operation of any one of the interactive competition formats, wherein the terminal corresponds to a target live streaming sub-picture, the target live streaming sub-picture including a live streaming sub-picture except a live streaming sub-picture corresponding to the target terminal, and the interaction request is initiated to request joint live streaming in the interactive competition format.

The displaying unit 1201 is further configured to display live streaming video streams in the joint live streaming picture in response to acknowledgement information returned from the terminal, wherein the live streaming video streams are video streams of the target terminal and the terminal in the interactive competition format.

With regard to the apparatus in the above embodiment, the details about performing the operations by respective units have been described in detail in the embodiments of the related method for displaying the interaction information, which are not described in detail herein.

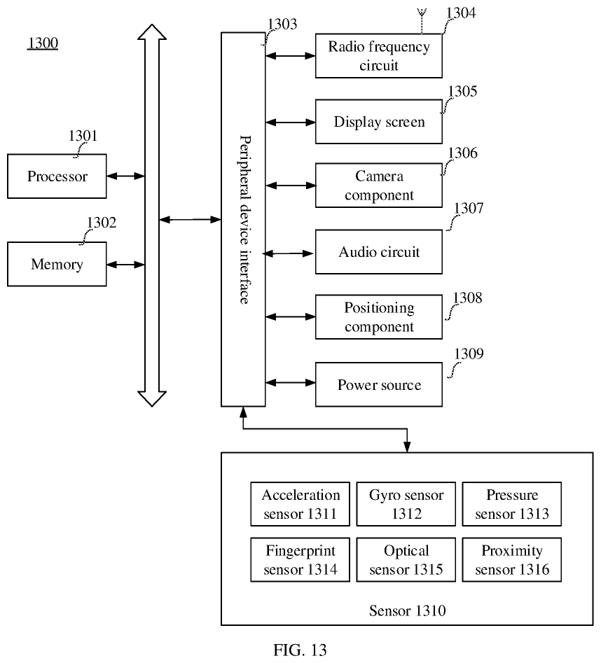

FIG. 13 shows a structural block diagram of a terminal 1300 according to an embodiment of the present disclosure. The terminal 1300 may be a smart phone, a tablet computer, a moving picture experts group audio layer III (MP3) player, a moving picture experts group audio layer IV (MP4) player, a laptop portable computer or a desktop computer. The terminal 1300 may also be referred to as a user device, a portable terminal, a laptop terminal, a desktop terminal, and the like.

Generally, the terminal 1300 includes a processor 1301 and a memory 1302.

The processor 1301 may include one or more processing cores, such as a 4-core processor, an 8-core processor, or the like. The processor 1300 may be practiced in at least one of hardware forms of a digital signal processor (DSP), a field-programmable gate array (FPGA), and a programmable logic array (PLA). The processor 1301 may also include a main processor and a coprocessor. The main processor is a processor for processing the data in an awake state, and is also called a central processing unit (CPU). The coprocessor is a low-power-consumption processor for processing the data in a standby state. In some embodiments, the processor 1301 may be integrated with a graphics processing unit (GPU), which is configured to render and draw the content that needs to be displayed by a display screen. In some embodiments, the processor 1301 may also include an Artificial Intelligence (AI) processor configured to process computational operations related to machine learning.

The memory 1302 may include one or more computer-readable storage media, which may be non-transitory. The memory 1302 may also include a high-speed random-access memory, as well as a non-volatile memory, such as one or more disk storage devices and flash storage devices. In some embodiments, the non-transitory computer-readable storage medium in the memory 1302 is configured to store one or more instructions. The one or more instructions, when executed by the processor 1301, cause the processor 1301 to perform the method for displaying interaction information according to the method embodiments of the present disclosure.

In some embodiments, the terminal 1300 may also optionally include a peripheral device interface 1303 and at least one peripheral device. The processor 1301, the memory 1302, and the peripheral device interface 1303 may be connected by a bus or a signal line. Each peripheral device may be connected to the peripheral device interface 1303 by a bus, a signal line, or a circuit board. Specifically, the peripheral device includes at least one of a radio frequency circuit 1304, a display screen 1305, a camera component 1306, an audio circuit 1307, a positioning component 1308 and a power source 1309.

The peripheral device interface 1303 may be configured to connect at least one peripheral device associated with an input/output (I/O) to the processor 1301 and the memory 1302. In some embodiments, the processor 1301, the memory 1302 and the peripheral device interface 1303 are integrated on the same chip or circuit board. In some other embodiments, any one or two of the processor 1301, the memory 1302 and the peripheral device interface 1303 may be practiced on a separate chip or circuit board, which is not limited in this embodiment.

The radio frequency circuit 1304 is configured to receive and transmit a radio frequency (RF) signal, which is also referred to as an electromagnetic signal. The radio frequency circuit 1304 communicates with a communication network and other communication devices via the electromagnetic signal. The radio frequency circuit 1304 converts an electrical signal into an electromagnetic signal for transmission, or converts the received electromagnetic signal into an electrical signal. In some embodiments, the radio frequency circuit 1304 includes an antenna system, an RF transceiver, one or more amplifiers, a tuner, an oscillator, a digital signal processor, a codec chipset, a user identity module card, and the like. The radio frequency circuit 1304 can communicate with other terminals via at least one wireless communication protocol. The wireless communication protocol includes, but not limited to, a metropolitan area network, various generations of mobile communication networks (2G, 3G, 4G, and 5G), a wireless local area network, and/or a wireless fidelity (Wi-Fi) network. In some embodiments, the RF circuit 1304 may also include a near-field communication (NFC) related circuit, which is not limited in the present disclosure.

The display screen 1305 is configured to display a user interface (UI). The UI may include graphics, texts, icons, videos, and any combination thereof. When the display screen 1305 is a touch display screen, the display screen 1305 also has the capability to acquire touch signals on or over the surface of the display screen 1305. The touch signal may be input into the processor 1301 as a control signal for processing. At this time, the display screen 1305 may also be configured to provide virtual buttons and/or virtual keyboards, which are also referred to as soft buttons and/or soft keyboards. In some embodiments, one display screen 1305 may be disposed on the front panel of the terminal 1300. In some other embodiments, at least two display screens 1305 may be disposed respectively on different surfaces of the terminal 1300 or in a folded design. In further embodiments, the display screen 1305 may be a flexible display screen disposed on a bending surface or a folded face of the terminal 1300. Moreover, the display screen 1305 may be defined to an irregular shape other than a rectangle, that is, the display screen 1305 may be an irregular-shaped screen. The display screen 1305 may be manufactured in the material of a liquid crystal display (LCD), an organic light-emitting diode (OLED) or the like.

The camera component 1306 is configured to capture images or videos. In some embodiments, the camera component 1306 includes a front camera and a rear camera. Generally, the front camera is disposed on the front panel of the terminal 1300, and the rear camera is disposed on the back of the terminal 1300. In some embodiments, at least two rear cameras are disposed, and are any one of a primary camera, a depth-of-field camera, a wide-angle camera, and a telephoto camera respectively, so as to realize a background blurring function achieved by fusion of the primary camera and the depth-of-field camera, panoramic shooting and virtual reality (VR) shooting functions achieved by fusion of the primary camera and the wide-angle camera or other fusion shooting functions. In some embodiments, the camera component 1306 may also include a flashlight. The flashlight may be a mono-color temperature flashlight or a two-color temperature flashlight. The two-color temperature flashlight is a combination of a warm flashlight and a cold flashlight and can be used for light compensation at different color temperatures.

The audio circuit 1307 may include a microphone and a speaker. The microphone is configured to acquire sound waves of users and environments, and convert the sound waves into electrical signals which are input into the processor 1301 for processing, or input into the RF circuit 1304 for voice communication. For the purpose of stereo acquisition or noise reduction, there may be a plurality of microphones respectively disposed at different parts of the terminal 1300. The microphone may also be an array microphone or an omnidirectional acquisition microphone. The speaker is then configured to convert the electrical signals from the processor 1301 or the radio frequency circuit 1304 into the sound waves. The speaker may be a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 1307 may also include a headphone jack.

The positioning component 1308 is configured to position a current geographic location of the terminal 1300 to implement navigation or a location-based service (LBS). The positioning component 1308 may be the United States' Global Positioning System (GPS), Russia's Global Navigation Satellite System (GLONASS), China's BeiDou Navigation Satellite System (BDS), and the European Union's Galileo.

The power source 1309 is configured to power up various components in the terminal 1300. The power source 1309 may be alternating current, direct current, a disposable battery, or a rechargeable battery. When the power source 1309 includes the rechargeable battery, the rechargeable battery may support wired or wireless charging. The rechargeable battery may also support the fast charging technology.

In some embodiments, the terminal 1300 also includes one or more sensors 1310. The one or more sensors 1310 include, but not limited to, an acceleration sensor 1311, a gyro sensor 1312, a pressure sensor 1313, a fingerprint sensor 1314, an optical sensor 1315, and a proximity sensor 1316.

The acceleration sensor 1311 may detect magnitudes of accelerations on three coordinate axes of a coordinate system established by the terminal 1300. For example, the acceleration sensor 1311 may be configured to detect components of a gravitational acceleration on the three coordinate axes. The processor 1301 may control the display screen 1305 to display a user interface in a transverse view or a longitudinal view based on a gravity acceleration signal acquired by the acceleration sensor 1311. The acceleration sensor 1311 may also be configured to acquire motion data of a game or a user.

The gyro sensor 1312 may detect a body direction and a rotation angle of the terminal 1300, and may cooperate with the acceleration sensor 1311 to acquire a 3D motion of the user on the terminal 1300. Based on the data acquired by the gyro sensor 1312, the processor 1301 can serve the following functions: motion sensing (such as changing the UI based on a user's tilt operation), image stabilization during shooting, game control and inertial navigation.

The pressure sensor 1313 may be disposed on a side frame of the terminal 1300 and/or a lower layer of the display screen 1305. When the pressure sensor 1313 is disposed on the side frame of the terminal 1300, a user holding signal to the terminal 1300 can be detected. The processor 1301 can perform left-right hand recognition or quick operation based on the holding signal acquired by the pressure sensor 1313. When the pressure sensor 1313 is disposed on the lower layer of the display screen 1305, the processor 1301 controls an operable control on the UI based on a user press operation on the display screen 1305. The operable control includes at least one of a button control, a scroll bar control, an icon control, and a menu control.

The fingerprint sensor 1314 is configured to acquire a user fingerprint. The processor 1301 identifies the user identity based on the fingerprint acquired by the fingerprint sensor 1314, or the fingerprint sensor 1314 identifies the user identity based on the acquired fingerprint. When the user identity is identified as trusted, the processor 1301 authorizes the user to perform related sensitive operations, such as unlocking the screen, viewing encrypted information, downloading software, paying, and changing settings. The fingerprint sensor 1314 may be disposed on the front, back, or side of the terminal 1300. When the terminal 1300 is provided with a physical button or a manufacturer logo, the fingerprint sensor 1314 may be integrated with the physical button or the manufacturer logo.

The optical sensor 1315 is configured to acquire ambient light intensity. In one embodiment, the processor 1301 may control the display luminance of the display screen 1305 based on the ambient light intensity acquired by the optical sensor 1315. Specifically, when the ambient light intensity is higher, the display luminance of the display screen 1305 is increased; and when the ambient light intensity is lower, the display luminance of the display screen 1305 is decreased. In another embodiment, the processor 1301 may also dynamically adjust shooting parameters of the camera component 1306 based on the ambient light intensity acquired by the optical sensor 1315.

The proximity sensor 1316, also referred to as a distance sensor, is usually disposed on the front panel of the terminal 1300. The proximity sensor 1316 is configured to determine a distance between the user and a front face of the terminal 1300. In one embodiment, when the proximity sensor 1316 detects that the distance between the user and the front face of the terminal 1300 gradually decreases, the processor 1301 controls the display screen 1305 to switch from a screen-on state to a screen-off state. When the proximity sensor 1316 detects that the distance between the user and the front face of the terminal 1300 gradually increases, the processor 1301 controls the display screen 1305 to switch from the screen-off state to the screen-on state.

It can be understood by those skilled in the art that the structure shown in FIG. 13 does not constitute a limitation to the terminal 1300. The terminal 1300 may include more or less components than those illustrated, or combine some components or adopt different component arrangements.

In some embodiments, the terminal includes: one or more processors, and one or more memories configured to store one or more computer programs including one or more executable instructions. The one or more computer programs, when loaded and run by the one or more processors, cause the one or more processor to execute instructions for: displaying a joint live streaming picture in a live streaming interface, wherein the joint live streaming picture includes a plurality of live streaming sub-pictures; playing, in each of the live streaming sub-pictures, live streaming video streams of a terminal corresponding to the live streaming sub-picture in a plurality of interaction rounds, wherein each of the interaction rounds includes a round of interactions of the terminal; and displaying interaction result information in the joint live streaming picture in response to an end of a last interaction round, wherein the interaction result information indicates an accumulated interaction result of the terminals in the plurality of interaction rounds.

In some embodiments, the one or more computer programs, when loaded and run by the one or more processors, cause the one or more processor to execute instructions for: displaying the interaction result information as Victory in response to interaction results of the terminal being Victory in more than half of the interaction rounds; displaying the interaction result information as Defeat in response to interaction results of the terminal being Defeat in more than half of the interaction rounds; or displaying the interaction result information as Draw in response to interaction results of the terminal being Victory in half of the interaction rounds.

In some embodiments, the one or more computer programs, when loaded and run by the one or more processors, cause the one or more processor to execute an instruction for: displaying interaction score information of the terminal in any one of the interaction rounds in the joint live streaming picture, wherein the interaction score information in the plurality of interaction rounds is intended to determine the interaction result information.

In some embodiments, the one or more computer programs, when loaded and run by the one or more processors, cause the one or more processor to execute an instruction for: dynamically displaying the interaction score information of the terminal in a strip form in each of the live streaming sub-pictures.

In some embodiments, the one or more computer programs, when loaded and run by the one or more processors, cause the one or more processor to execute an instruction for: displaying a target strip in the joint live streaming picture, wherein the target strip includes a plurality of segments each representing interaction score information of the terminal in the interaction round.

In some embodiments, the one or more computer programs, when loaded and run by the one or more processors, cause the one or more processor to execute an instruction for: adding an interactive special effect to the interaction score information in the joint live streaming picture within a target time period before an end time of the interaction rounds, wherein the interactive special effect indicates that accumulation of the interaction score information stops after the target time period.

In some embodiments, the one or more computer programs, when loaded and run by the one or more processors, cause the one or more processor to execute instructions for : playing a start animation for any one of the interaction rounds at a start time of the interaction round, wherein the start animation indicates that the interaction round starts; and playing an end animation for the interaction round at an end time of the interaction round, wherein the end animation indicates that the interaction round ends.

In some embodiments, a target terminal includes: one or more processors, and one or more memories configured to store one or more computer programs including one or more executable instructions, wherein the one or more computer programs, when loaded and run by the one or more processors, cause the one or more processors to execute instructions for: displaying a joint live streaming picture in a live streaming interface, wherein the joint live streaming picture includes a plurality of live streaming sub-pictures and a competition format switch option; displaying a plurality of switchable interactive competition formats in the joint live streaming picture in response to a trigger operation of the competition format switch option, wherein the interactive competition format indicates the number of interaction rounds under a competition format and the number of winnings required for victory; sending an interaction request to a terminal in response to a trigger operation of any one of the interactive competition formats, wherein the terminal corresponds to a target live streaming sub-picture, the target live streaming sub-picture including a live streaming sub-picture except a live streaming sub-picture corresponding to the target terminal, and the interaction request is initiated to request joint live streaming in the interactive competition format; and displaying live streaming video streams in the joint live streaming picture in response to acknowledgement information returned from the terminal, wherein the live streaming video streams are video streams of the target terminal and the terminal in the interactive competition format.

In some embodiments, configured to store one or more computer programs including one or more executable instructions, such as a memory, is provided. The one or more computer programs, when loaded and run by one or more processors of a terminal, cause the terminal to perform the method for displaying the interaction information according to any of the above embodiment.

In some embodiments, the storage medium may be a non-transitory computer-readable storage medium. For example, the non-transitory computer-readable storage medium may include a read-only memory (ROM), a random-access memory (RAM), a compact disc read-only memory, (CD-ROM), a magnetic tape, a floppy disk, an optical data storage device, or the like.

In some embodiments, the one or more computer programs, when loaded and run by the one or more processors, cause the one or more processors to execute instructions for: displaying a joint live streaming picture in a live streaming interface, wherein the joint live streaming picture includes a plurality of live streaming sub-pictures; playing, in each of the live streaming sub-pictures, live streaming video streams of a terminal corresponding to the live streaming sub-picture in a plurality of interaction rounds, wherein each of the interaction rounds includes a round of interactions of the terminal; and displaying interaction result information in the joint live streaming picture in response to an end of a last interaction round, wherein the interaction result information indicates an accumulated interaction result of the terminals in the plurality of interaction rounds.

In some embodiments, the one or more computer programs, when loaded and run by the one or more processors, cause the one or more processors to execute instructions for: displaying the interaction result information as Victory in response to interaction results of the terminal being Victory in more than half of the interaction rounds; displaying the interaction result information as Defeat in response to interaction results of the terminal being Defeat in more than half of the interaction rounds; or displaying the interaction result information as Draw in response to interaction results of the terminal being Victory in half of the interaction rounds.

In some embodiments, the one or more computer programs, when loaded and run by the one or more processors, cause the one or more processors to execute an instruction for: displaying interaction score information of the terminal in any one of the interaction rounds in the joint live streaming picture, wherein the interaction score information in the plurality of interaction rounds is intended to determine the interaction result information.

In some embodiments, the one or more computer programs, when loaded and run by the one or more processors, cause the one or more processors to execute an instruction for: dynamically displaying the interaction score information of the terminal in a strip form in each of the live streaming sub-pictures.

In some embodiments, the one or more computer programs, when loaded and run by the one or more processors, cause the one or more processors to execute an instruction for: displaying a target strip in the joint live streaming picture, wherein the target strip includes a plurality of segments each indciating interaction score information of the terminal in the interaction round.

In some embodiments, the one or more computer programs, when loaded and run by the one or more processors, cause the one or more processors to execute an instruction for: adding an interactive special effect to the interaction score information in the joint live streaming picture within a target time period before an end time of the interaction rounds, wherein the interactive special effect indicates that accumulation of the interaction score information stops after the target time period.

In some embodiments, the one or more computer programs, when loaded and run by the one or more processors, cause the one or more processors to execute instructions for: playing a start animation for any one of the interaction rounds at a start time of the interaction round, wherein the start animation indicates that the interaction round starts; and playing an end animation for the interaction round at an end time of the interaction round, wherein the end animation indicates that the interaction round ends.

In some embodiments, the one or more computer programs, when loaded and run by the one or more processors, cause the one or more processors to execute instruction fors: displaying a joint live streaming picture in a live streaming interface, wherein the joint live streaming picture includes a plurality of live streaming sub-pictures and a competition format switch option; displaying a plurality of switchable interactive competition formats in the joint live streaming picture in response to a trigger operation of the competition format switch option, wherein the interactive competition format indicates the number of interaction rounds under a competition format and the number of winnings required for victory; sending an interaction request to a terminal in response to a trigger operation of any one of the interactive competition formats, wherein the terminal corresponds to a target live streaming sub-picture, the target live streaming sub-picture including a live streaming sub-picture except a live streaming sub-picture corresponding to the target terminal, and the interaction request is initiated to request joint live streaming in the interactive competition format; and displaying live streaming video streams in the joint live streaming picture in response to acknowledgement information returned from the terminal, wherein the live streaming video streams are video streams of the target terminal and the terminal in the interactive competition format.

In some embodiments, a computer program product is further provided. The computer program product includes one or more instructions. The one or more instructions, when executed by a processor of a terminal, cause the terminal to perform the method for displaying the interaction information according to any one of the above embodiments.

Other embodiments of the present disclosure are apparent to those skilled in the art from consideration of the specification and practice of the present disclosure disclosed herein. The present disclosure is intended to cover any variations, uses, or adaptations of the present disclosure following the general principles thereof and including common knowledge or commonly used technical measures which are not disclosed herein. The specification and embodiments are to be considered as examples only, with a true scope and spirit of the present disclosure being indicated by the following claims.

It should be appreciated that the present disclosure is not limited to the exact construction that has been described above and illustrated in the accompanying drawings, and that various modifications and changes can be made without departing from the scope thereof. The scope of the present disclosure is only subject to the appended claims.

What is claimed is:

1. A method for displaying interaction information, comprising:
displaying a joint live streaming picture in a live streaming interface, wherein the joint live streaming picture comprises a plurality of live streaming sub-pictures;
playing, in each of the live streaming sub-pictures, live streaming video streams of a terminal corresponding to the live streaming sub-picture in a plurality of interaction rounds, wherein each of the interaction rounds comprises a round of interactions of the terminal; and
displaying interaction result information in the joint live streaming picture in response to an end of a last interaction round, wherein the interaction result information indicates an accumulated interaction result of the terminal in the plurality of interaction rounds.

2. The method according to claim 1, further comprising:
displaying the interaction result information as Victory in response to interaction results of the terminal being Victory in more than half of the interaction rounds;
displaying the interaction result information as Defeat in response to interaction results of the terminal being Defeat in more than half of the interaction rounds; or
displaying the interaction result information as Draw in response to interaction results of the terminal being Victory in half of the interaction rounds.

3. The method according to claim 1, further comprising:
displaying interaction score information of the terminal in any one of the interaction rounds in the joint live streaming picture, wherein the interaction score information in the plurality of interaction rounds is intended to determine the interaction result information.

4. The method according to claim 3, wherein said displaying the interaction score information of the terminal in the any one of the interaction rounds in the joint live streaming picture comprises:
dynamically displaying the interaction score information of the terminal in a strip form in each of the live streaming sub-pictures.

5. The method according to claim 3, wherein said displaying the interaction score information of the terminal in the any one of the interaction rounds in the joint live streaming picture comprises:
displaying a target strip in the joint live streaming picture, wherein the target strip comprises a plurality of segments each representing the interaction score information of the terminal in the interaction round.

6. The method according to claim 3, wherein said displaying the interaction score information of the terminal in the any one of the interaction rounds in the joint live streaming picture comprises:
adding an interactive special effect to the interaction score information in the joint live streaming picture within a target time period before an end time of the interaction rounds, wherein the interactive special effect indicates that accumulation of the interaction score information stops after the target time period.

7. The method according to claim 1, further comprising:
playing a start animation for the interaction round at a start time of the interaction round, wherein the start animation indicates that the interaction round is starting; and
playing an end animation for the interaction round at an end time of the interaction round, wherein the end animation indicates that the interaction round is ending.

8. A method for displaying interaction information, applicable to a target terminal, comprising:
displaying a joint live streaming picture in a live streaming interface, wherein the joint live streaming picture comprises a plurality of live streaming sub-pictures and a competition format switch option;
displaying a plurality of switchable interactive competition formats in the joint live streaming picture in response to a trigger operation of the competition format switch option, wherein the interactive competition format indicates a number of interaction rounds under a competition format and a number of winnings required for victory;
sending an interaction request to a terminal in response to a trigger operation of any one of the interactive competition formats, wherein the terminal corresponds to a target live streaming sub-picture, the target live streaming sub-picture comprising a live streaming sub-picture except a live streaming sub-picture corresponding to the target terminal, and the interaction request is initiated to request joint live streaming in the interactive competition format; and
displaying live streaming video streams in the joint live streaming picture in response to acknowledgement information returned from the terminal, wherein the live streaming video streams are video streams of the target terminal and the terminal in the interactive competition format.

9. A terminal, comprising:
one or more processors; and
one or more memories configured to store one or more instructions executable by the one or more processors,
wherein the one or more instructions, when executed by the one or more processors, cause the one or more processors to perform a method comprising:
displaying a joint live streaming picture in a live streaming interface, wherein the joint live streaming picture comprises a plurality of live streaming sub-pictures;
playing, in each of the live streaming sub-pictures, live streaming video streams of a terminal corresponding to the live streaming sub-picture in a plurality of interaction rounds, wherein each of the interaction rounds comprises a round of interactions of the terminal; and
displaying interaction result information in the joint live streaming picture in response to an end of a last interaction round, wherein the interaction result information indicates an accumulated interaction result of the terminal in the plurality of interaction rounds.

10. The terminal according to claim 9, wherein the method further comprises:
displaying the interaction result information as Victory in response to interaction results of the terminal being Victory in more than half of the interaction rounds;
displaying the interaction result information as Defeat in response to interaction results of the terminal being Defeat in more than half of the interaction rounds; or
displaying the interaction result information as Draw in response to interaction results of the terminal being Victory in half of the interaction rounds.

11. The terminal according to claim 9, wherein the method further comprises:
displaying interaction score information of the terminal in any one of the interaction rounds in the joint live streaming picture, wherein the interaction score information in the plurality of interaction rounds is intended to determine the interaction result information.

12. The terminal according to claim 11, wherein said displaying the interaction score information of the terminal in the any one of the interaction rounds in the joint live streaming picture comprises:
dynamically displaying the interaction score information of the terminal in a strip form in each of the live streaming sub-pictures.

13. The terminal according to claim 11, wherein said displaying the interaction score information of the terminal in the any one of the interaction rounds in the joint live streaming picture comprises:
displaying a target strip in the joint live streaming picture, wherein the target strip comprises a plurality of segments each representing the interaction score information of the terminal in the interaction round.

14. The terminal according to claim 11, wherein said displaying the interaction score information of the terminal in the any one of the interaction rounds in the joint live streaming picture comprises:
adding an interactive special effect to the interaction score information in the joint live streaming picture within a target time period before an end time of the interaction rounds, wherein the interactive special effect indicates that accumulation of the interaction score information stops after the target time period.

15. The terminal according to claim 9, wherein the method further comprises:
playing a start animation for the interaction round at a start time of the interaction round, wherein the start animation indicates that the interaction round is starting; and
playing an end animation for the interaction round at an end time of the interaction round, wherein the end animation indicates that the interaction round is ending.
